(19) United States
(12) Patent Application Publication
(10) Pub. No.: US 2017/0201800 A1
(43) Pub. Date: Jul. 13, 2017

(54) DISPLAY DEVICE AND OPERATION METHOD THEREOF

(71) Applicant: Samsung Electronics Co., Ltd., Gyeonggi-do (KR)

(72) Inventors: Hanchul JUNG, Gyeonggi-do (KR); Do-Sung JUNG, Seoul (KR); Eunbi KIM, Seoul (KR); Su-Hyun NA, Seoul (KR); Soojung LEE, Seoul (KR); Olivia LEE, Seoul (KR)

(73) Assignee: Samsung Electronics Co., Ltd.

(21) Appl. No.: 15/403,702

(22) Filed: Jan. 11, 2017

(30) Foreign Application Priority Data
Jan. 11, 2016 (KR) 10-2016-0003105

(51) Int. Cl. H04N 21/482; H04N 21/422; H04N 21/485

(52) U.S. Cl. CPC H04N 21/482; H04N 21/485; H04N 21/42204

(57) ABSTRACT

A method for use with a display device is provided. The method includes outputting content corresponding to a predetermined channel, capturing screen data included in the outputted content, determining content information associated with the screen data from a previously stored electronic program guide, and setting the predetermined channel as a reference channel based on the determined content information.

### PRIORITY

This application claims priority under 35 U.S.C. §119(a) to Korean Patent Application Serial No. 10-2016-0003105, which was filed in the Korean Intellectual Property Office on Jan. 11, 2016, the entire content of which is incorporated herein by reference.

### BACKGROUND

1. Field of the Disclosure

The present disclosure relates generally to a display device, and more particularly, to a display device that is capable of controlling a channel.

2. Description of the Related Art

Digital TV services may provide various services that are typically not provided by existing analog broadcasting services. Particularly, the digital TV services exhibit greater control of external noise, have lower data loss, and provide better error correction when compared to analog broadcasting services. Also, the digital TV services have a higher resolution and provide a finer, crisper screen when compared to the analog broadcasting services. Also, some digital TV services may be capable of providing bi-directional services, unlike the analog broadcasting services. The above mentioned advantages have led to the popularization of the digital TV services using a wired or wireless communication network.

In accordance with conventional digital TV service, in order to register a currently viewed channel as a favorite channel, the digital TV service is required to call (or retrieve) the entire channel list provided by a digital TV, search the channel list for the desired channel, and add the channel for registering the channel as a favorite channel, which can be rather time consuming and thus inconvenient for a user.

### SUMMARY

According to an aspect of the present disclosure, there is provided a display device that can register a currently viewed channel as a favorite channel, and further provide an operation method thereof.

According to an aspect of the present disclosure, there is provided a display device that registers at least one channel in a favorite channel list and enables a user to readily select a desired channel through the favorite channel list whenever the user desires to view the channel, thereby reducing an amount of time consumed for selecting a channel.

In accordance with an aspect of the present disclosure, there is provided a method for use with a display device. The method includes outputting content corresponding to a predetermined channel, capturing screen data included in the outputted content, determining content information associated with the screen data from a previously stored electronic program guide, and setting the predetermined channel as a reference channel based on the determined content information.

In accordance with an aspect of the present disclosure, there is provided an electronic device. The electronic device includes an image outputting unit configured to display screen data included in content corresponding to a predetermined channel and a controller configured to capture the screen data, determine content information associated with the screen data from an electronic program guide, and set the predetermined channel as a reference channel according to the determined content information.

### BRIEF DESCRIPTION OF THE DRAWINGS

The above and other aspects, features, and advantages of certain embodiments of the present disclosure will be more apparent from the following detailed description taken in conjunction with the accompanying drawings, in which:

FIG. 1 is a diagram illustrating a system for providing a content in a display device, according to an embodiment of the present disclosure;

FIG. 2 is a block diagram illustrating a main configuration of a display device, according to an embodiment of the present disclosure;

FIG. 3 is a block diagram illustrating a configuration of a remote control device, according to an embodiment of the present disclosure;

FIG. 4 is a signaling diagram of a method in which a system sets a reference channel, according to an embodiment of the present disclosure;

FIG. 5 is a signaling diagram of a method in which a system changes a channel in a channel list, according to an embodiment of the present disclosure;

FIG. 6 is a flowchart of a method of a display device, according to an embodiment of the present disclosure;

FIG. 7 is a flowchart of a method in which a display device estimates a currently viewed channel, according to an embodiment of the present disclosure;

FIG. 8 is a flowchart of a method in which a display device controls a channel list, according to an embodiment of the present disclosure;

FIG. 9 is a flowchart of a method in which a display device controls a channel in a channel list, according to an embodiment of the present disclosure;

FIGS. 10A to 10C are diagrams illustrating screens in association with a method for a display device to register a currently viewed channel in a channel list, according to an embodiment of the present disclosure;

FIGS. 11A to 11C are diagrams illustrating screens in association with a method for a display device to change a currently viewed channel to another channel in a channel list, according to an embodiment of the present disclosure;

FIGS. 12A to 12D are diagrams illustrating screens in association with a method for a display device to edit a channel list, according to an embodiment of the present disclosure;

FIG. 13 is a flowchart of a method in which a system sets a reference channel when changing a channel, according to an embodiment of the present disclosure;

FIG. 14 is a flowchart of a method in which a display device changes a reference channel as a channel is changed, according to an embodiment of the present disclosure; and

FIG. 15 is a flowchart of a method in which a display device estimates a changed channel, according to an embodiment of the present disclosure.

### DETAILED DESCRIPTION

Embodiments of the present disclosure will be described herein below with reference to the accompanying drawings. However, the embodiments of the present disclosure are not limited to the specific embodiments and should be construed as including all modifications, changes, equivalent devices and methods, and/or alternative embodiments of the present disclosure.

The terms “A or B,” “at least one of A or/and B,” or “one or more of A or/and B” as used herein include all possible combinations of items enumerated with them. For example, “A or B,” “at least one of A and B,” or “at least one of A or B” means (1) including at least one A, (2) including at least one B, or (3) including both at least one A and at least one B.

The terms such as “first” and “second” as used herein may modify various elements regardless of an order and/or importance of the corresponding elements, and do not limit the corresponding elements. These terms may be used for the purpose of distinguishing one element from another element. For example, a first user device and a second user device may indicate different user devices regardless of the order or importance. For example, a first element may be referred to as a second element without departing from the scope the present invention, and similarly, a second element may be referred to as a first element.

The expression “configured to (or set to)” as used herein may be used interchangeably with “suitable for,” “having the capacity to,” “designed to,” “adapted to,” “made to,” or “capable of” according to a context. The term “configured to (set to)” does not necessarily mean “specifically designed to” in a hardware level. Instead, the expression “apparatus configured to . . . ” may mean that the apparatus is “capable of . . . ” along with other devices or parts in a certain context. For example, “a processor configured to (set to) perform A, B, and C” may mean a dedicated processor (e.g., an embedded processor) for performing a corresponding operation, or a generic-purpose processor (e.g., a CPU or an application processor) capable of performing a corresponding operation by executing one or more software programs stored in a memory device.

The term “module” as used herein may be defined as, for example, a unit including one of hardware, software, and firmware or two or more combinations thereof. The term “module” may be interchangeably used with, for example, the terms “unit”, “logic”, “logical block”, “component”, or “circuit”, and the like. The “module” may be a minimum unit of an integrated component or a part thereof. The “module” may be a minimum unit performing one or more functions or a part thereof. The “module” may be mechanically or electronically implemented. For example, the “module” may include at least one of an application-specific integrated circuit (ASIC) chip, field-programmable gate arrays (FPGAs), or a programmable-logic device, which is well known or will be developed in the future, for performing certain operations.

Electronic devices according to the embodiments of the present disclosure may include at least one of, for example, smart phones, tablet personal computers (PCs), mobile phones, video telephones, electronic book readers, desktop PCs, laptop PCs, netbook computers, workstations, servers, personal digital assistants (PDAs), portable multimedia players (PMPs), Motion Picture Experts Group (MPEG-1 or MPEG-2) Audio Layer 3 (MP3) players, mobile medical devices, cameras, or wearable devices. According to an embodiment of the present disclosure, the wearable devices may include at least one of accessory-type wearable devices (e.g., watches, rings, bracelets, anklets, necklaces, glasses, contact lenses, or head-mounted-devices (HMDs)), fabric or clothing integral wearable devices (e.g., electronic clothes), body-mounted wearable devices (e.g., skin pads or tattoos), or implantable wearable devices (e.g., implantable circuits).

The electronic devices may be smart home appliances. The smart home appliances may include at least one of, for example, televisions (TVs), digital versatile disk (DVD) players, audios, refrigerators, air conditioners, cleaners, ovens, microwave ovens, washing machines, air cleaners, set-top boxes, home automation control panels, security control panels, TV boxes (e.g., Samsung HomeSync™, Apple TV™, or Google TV™), game consoles (e.g., Xbox™ and PlayStation™), electronic dictionaries, electronic keys, camcorders, or electronic picture frames.

The electronic devices may include at least one of various medical devices (e.g., various portable medical measurement devices (such as blood glucose meters, heart rate monitors, blood pressure monitors, or thermometers, and the like), a magnetic resonance angiography (MRA) device, a magnetic resonance imaging (MRI) device, a computed tomography (CT) device, scanners, or ultrasonic devices, and the like), navigation devices, global positioning system (GPS) receivers, event data recorders (EDRs), flight data recorders (FDRs), vehicle infotainment devices, electronic equipment for vessels (e.g., navigation systems, gyrocompasses, and the like), avionics, security devices, head units for vehicles, industrial or home robots, automatic teller machines (ATMs), points of sales (POSs) devices, or Internet of Things (IoT) devices (e.g., light bulbs, various sensors, electric or gas meters, sprinkler devices, fire alarms, thermostats, street lamps, toasters, exercise equipment, hot water tanks, heaters, boilers, and the like).

The electronic devices may further include at least one of parts of furniture or buildings/structures, electronic boards, electronic signature receiving devices, projectors, or various measuring instruments (such as water meters, electricity meters, gas meters, or wave meters, and the like). The electronic devices may be one or more combinations of the above-mentioned devices. The electronic devices may be flexible electronic devices. Also, the electronic devices are not limited to the above-mentioned devices, and may include new electronic devices according to the development of new technologies.

Hereinafter, the electronic devices according to various embodiments of the present disclosure will be described with reference to the accompanying drawings. The term “user” as used herein may refer to a person who uses an electronic device or may refer to a device (e.g., an artificial intelligence electronic device) which uses an electronic device.

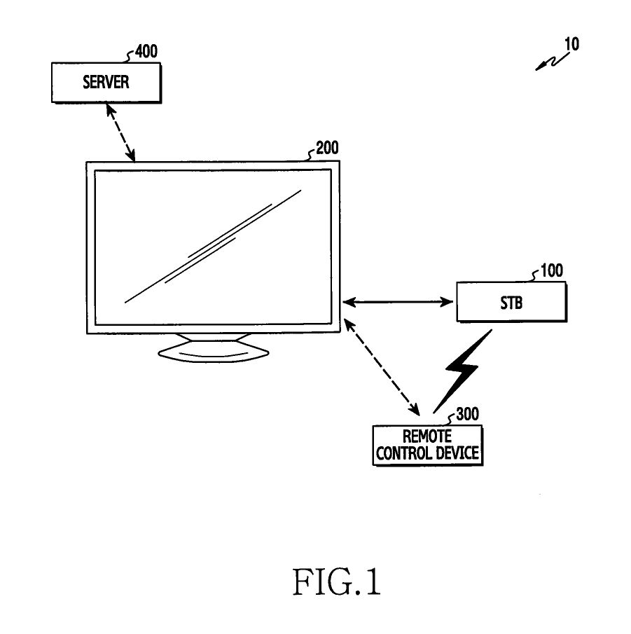

FIG. 1 is a diagram illustrating a system for providing content in a display device, according to an embodiment of the present disclosure.

Referring to FIG. 1, a system 10 includes a set top box 100 (STB 100), a display device 200, a remote control device 300, and a server 400.

The STB 100 may receive and process a broadcasting signal from a broadcasting server. The STB 100 may receive electronic program guide (EPG) data from the broadcasting server. The EPG data may include a system time table, a master guide table, a virtual channel table, a level area table, and an event information table. The EPG data may be guide information associated with all channels provided to the display device 200, such as a plurality of channel numbers, a broadcasting company allocated to each channel number, titles of a plurality of contents provided from each channel number, a time table of content, a broadcasting start time of content, a broadcasting end time of content, or the like.

The STB 100 may include a broadcasting receiving unit and may receive a terrestrial broadcasting signal, a satellite broadcasting signal, a cable broadcasting signal, an IPTV broadcasting signal, and the like. The STB 100 may receive a broadcasting image from the broadcasting server through the broadcasting receiving unit, and may transmit the received broadcasting image to the display device 200 as content. The STB 100 may perform communication with the electronic device 200, and the STB 100 may perform infrared communication with the remote control device 300 so that the STB 100 may change a channel based on a channel change signal received from the remote control device 300, and the STB 100 may receive a broadcasting signal from the changed channel.

The display device 200 may output content received from the STB 100. The display device 200 may include a television, a monitor, a computer, or the like, which is capable of outputting content. The display device 200 may receive an EPG guide from the STB 100 periodically or in real time, and may store the same when the display device 200 is activated. The display device 200 may output content received from the STB 100 when the display device 200 is activated, and the content may include screen data and sound data.

The display device 200 may capture currently output screen data, transmit the same to the server 400, and receive content information associated with the screen data from the server 400. The display device 200 may search the EPG data for content information received from the server 400. When information related to the content information exists in the EPG data, the display device 200 may determine a channel number associated with a current channel that provides content. The display device 200 may set the determined channel number as a reference channel.

When a control signal associated with a channel list (e.g., a favorite channel list) is received from the remote control device 300, the display device 200 may control the channel list based on the control signal. For example, when an add signal for adding a set reference channel to the channel list is received from the remote control device 300, the display device 200 may add the reference channel to the channel list. When a signal for editing (e.g., deletion) the channel list is received from the remote control device 300, the display device 200 may delete, from the channel list, at least one channel included in the channel list. When a signal for editing (e.g., changing a sequence) the channel list is received from the remote control device 300, the display device 200 may change a sequence of at least one channel included in the channel list.

The display device 200 may receive a signal for changing a current channel to a predetermined channel out of the channels included in the channel list from the remote control device 300. More particularly, the display device 200 may change the current channel to a channel corresponding to the change signal, and may transmit a changed channel number to the remote control device 300. When the display device 200 includes a dongle (or other suitable piece of hardware) that is capable of performing infrared communication with the STB 100, the display device 200 may directly transmit the changed channel number to the STB 100. Also, when the display device 200 is capable of transmitting and receiving data to/from communication connected to the STB 100, the display device 200 may directly transmit the changed channel number to the STB 100.

The display device 200 may receive a channel change signal from the remote control device 300 when outputting content received from the STB 100. The channel change signal indicates a signal for directly changing a channel according to an up/down signal or an input signal associated with a predetermined number, which is input from the remote control device 300, instead of using a channel list. The display device 200 may sniff (or detect) a channel change signal output from the remote control device 300. The display device 200 may determine a type of channel change signal.

When a channel change signal output from the remote control device 300 is an up/down signal, the display device 200 may add/subtract the up/down signal to/from a channel number that provides a currently output content, and may determine a channel number of a desired channel of the remote control device 300. When the channel change signal output from the remote control device 300 is a signal associated with a predetermined number, the display device 200 may determine a channel number associated with the predetermined number as a channel number of a desired channel of the remote control device 300. The display device 200 may output content received from the STB 100 according to a channel change signal, and may reset a channel number that provides a currently output content as a reference channel. When a channel number determined based on a channel change signal output from the remote control device 300 and a channel number that provides content received from the STB 100 are different from each other, the display device 200 may reset a reference channel using the channel number that provides the content received from the STB 100.

The remote control device 300 may output a control signal associated with the STB 100 or the display device 200, and may include an electronic device, such as a remote controller, a smart phone, or the like. The remote control device 300 may perform infrared communication when communicating with the STB 100. The remote control device 300 may perform short-range wireless communication, such as bluetooth (BT), BT low energy (BLE), near field communication (NFC), or the like, for the communication with the display device 200.

The remote control device 300 may transmit, to the display device 200, a control signal for controlling a channel list stored in the display device 200 using one of the short-range wireless communication. The remote control device 300 may receive, from the display device 200, a channel number associated with a predetermined channel selected from the channel list through short-range wireless communication. The remote control device 300 may generate an infrared signal including the channel number received from the display device 200, and may transmit the same to the STB 100.

The STB 400 may perform communication with the electronic device 200, analyze screen data received from the display device 200, and determine content including the screen data. The server 400 may be an auto content recognition (ACR) server for analyzing screen data. The server 400 may parse text included in screen data, a time when the screen data is captured from the display device 200, and facial recognition (e.g., feature points recognition) included in the screen data, and the like. The server 400 may extract information associated with the content and may transmit the same to the display device 200, according to a result of the parsing operation being performed. The content information may include metadata of at least one of a broadcasting company that provides the content corresponding to the screen data, a channel number of a channel that provides the content, a title of the content, a broadcasting start time of the content, a broadcasting end time of the content, a logo of the content, a logo of a broadcasting company, and a thumbnail of the content.

Although embodiments of the present disclosure are provided from the perspective by which the display device 200 sets a reference channel using EPG data received from the STB 100, the present disclosure is not be limited thereto. For example, the server 400 may receive EPG data from a broadcasting server, and may store the same. The server 400 may analyze screen data received from the display device 200, and may extract content information. The server 400 may identify information that is the same as the content information, using the stored EPG data. The server 400 may determine a channel number of a channel that provides content related to the screen data based on the identified information. The server 400 may transmit, to the display device 200, the determined channel number, and the display device 200 may set the channel number received from the server 400 as a reference channel.

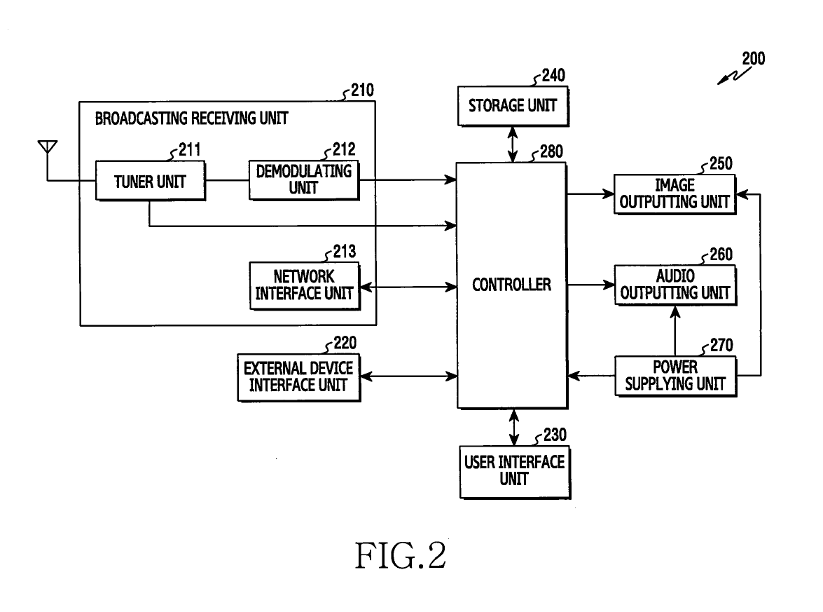

FIG. 2 is a block diagram illustrating a main configuration of the display device 200, according to an embodiment of the present disclosure.

Referring to FIG. 2, the display device 200includes a broadcasting receiving unit 210, an external device interface unit 220, a user interface unit 230, a storage unit 240, an image outputting unit 250, an audio outputting unit 260, a power supplying unit 270, and a controller 280.

The broadcasting unit 210 includes a tuner unit 211, a demodulating unit 212, and a network interface unit 213. The tuner unit 211 may select a radio frequency (RF) broadcasting signal corresponding to a channel selected by a user or all of the channels stored in advance, out of RF broadcasting signals received through an antenna, and may convert the selected RF broadcasting signal into an intermediate frequency signal or a baseband video or audio signal. For example, the tuner unit 211 may convert the selected RF broadcasting signal into a digital IF signal (DIF) when the selected RF broadcasting signal is a digital broadcasting signal, and converts the selected RF broadcasting signal into an analog baseband video or audio signal (CVBS(composite video baseband signal)/SIF(sound intermediate frequency)) when the selected RF broadcasting signal is an analog broadcasting signal.

The tuner unit 211 may process both a digital broadcasting signal and an analog broadcasting signal, and an analog base band video or audio signal output from the tuner unit 211 may be directly input into the controller 280. Also, the tuner unit 211 may receive an RF broadcasting signal of a single carrier according to an advanced television system committee (ATSC) scheme, and an RF broadcasting signal of a plurality of carriers according to a digital video broadcasting (DVB) scheme. The tuner unit 211 may sequentially select RF broadcasting signals of all of the broadcasting channels stored through a channel memory function, from among RF broadcasting signals received through an antenna, and may convert the same into intermediate frequency signals or baseband video or audio signals.

The demodulating unit 212 may receive a converted digital RF signal from the tuner unit 211, and may perform a demodulation operation. When the digital RF signal output from the tuner unit 211 is based on the ATSC scheme, the demodulating unit 212 may perform 8-vestigal side band (VSB) demodulation. The demodulating unit 212 may perform channel decoding, and may include a trellis decoder, a de-interleaver, and a reed Solomon decoder, and the like. For example, when a digital IF signal output from the tuner unit 211 is based on the DVB scheme, the demodulating unit 212 may perform a coded orthogonal frequency division multiple access (COFDMA) demodulation. The demodulating unit 212 may perform channel decoding. The demodulating unit 212 may include a convolution decoder, a de-interleaver, and a reed Solomon decoder.

The demodulating unit 212 may perform demodulation and channel decoding, and may output a stream signal. The stream signal may be a signal that is multiplexed from a video signal, an audio signal, or a data signal. The stream signal may be an MPEG-2 transport steam (TS) that is multiplexed from a video signal of the MPEG-2 standard, an audio signal of the Dolby AC-3 standard, or the like. The MPEG-2 TS may include a 4-byte header and a 184-byte payload. A header may include information indicating a start of a signal and a packet identifier (PID) associated with a signal contained in a payload, and the payload may include screen data and sound data. The demodulating unit 212 may include an ATSC demodulating unit and a DVB demodulating unit separately, according to the ATSC scheme and the DVB scheme. A stream signal output from the demodulating unit 212 may be input into the controller 280. The controller 280 may perform de-multiplexing, video/audio signal processing, or the like, output screen data to the image outputting unit 250, and output sound data to the audio outputting unit 260.

The network interface unit 213 may provide an interface for connecting the display device 200 to a wired/wireless network including an Internet network. The network interface unit 213 may include an Ethernet device or the like to access a wired network, and may access a wireless network using wireless local area network (WLA/V), wireless-fidelity (Wi-Fi), wireless broadband (WiBro), world interoperability for microwave access (WiMax), high speed downlink packet access (HSDPA) communication standard, or the like. The network interface unit 213 may transmit or receive data to/from another user or another electronic device, through a connected network or another network linked to the connected network. Content stored in the display device 200 may be transmitted to another user registered in advance in the display device 200 or an electronic device selected out of other electronic devices.

The network interface unit 213 may access a predetermined webpage through a connected network or another network linked to the connected network. The network interface unit 213 may transmit or receive data to/from the server 400 through a network. The network interface unit 213 may transmit, to the server 400, screen data included in content that is currently output from the display device 200. The network interface unit 213 may receive, from the server 400, information associated with content corresponding to screen data from the server 400, and may provide the same to the controller 280. The server 400 may parse text included in the screen data, a time when the screen data is captured from the display device 200, and facial recognition (e.g., feature points recognition) included in the screen data, and the like. The network interface unit 213 may receive content information including metadata of at least one of a broadcasting company that provides content corresponding to screen, a channel number of a channel that provides content, a title of content, a broadcasting start time of content, a broadcasting end time of content, a logo of content, a logo of a broadcasting company, and a thumbnail of content.

The network interface unit 213 may receive content or data provided by a content provider or a network operator. The network interface unit 213 may receive content, such as a movie, an advertisement, a game, a video-on-demand (VOD), a broadcasting signal, or the like, and information related thereto from a content provider or a network operator through a network. The network interface unit 213 may receive update information and an update file of firmware provided by a network operator, and may transmit data to an Internet or content provider or the network operator.

The external device interface unit 220 may connect an external device and the display device 200, and may include an audio/video A/V input/output unit, a wireless communication unit, or the like. The external device interface unit 220 may be wired/wirelessly connected with an external device, such as, a digital versatile disk (DVD), Blu-ray, a game device, a camera, a camcorder, a computer (notebook), the STB 100, or the like. The external device interface unit 220 may transfer, to the controller 280 of the display device 200, a video, an audio, or a data signal input from the outside through a connected external device, and may output, to the connected external device, a video, an audio, or a data signal processed in the controller 280.

The external device interface unit 220 may receive EPG data from the STB 100, and may provide the same to the controller 280. The EPG data may include a system time table, a master guide table, a virtual channel table, a level area table, and an event information table. The EPG data may be guide information associated with all channels provided to the display device 200, such as a plurality of channel numbers, titles of a plurality of contents provided from each channel number, a time table of content, a broadcasting start time of content, a broadcasting end time of content, or the like.

An A/V input/output unit may include a universal serial bus (USB) device, a composite video banking sync (CVBS) device, a component device, an S-video device (analog), a digital visual interface (DVI) device, a high definition multimedia interface (HDMI) device, a red, green, and blue (RGB) device, a D-SUB device, or the like, to input a video and audio signal of an external device into the display device 200. A wireless communication unit may perform short-range wireless communication with another electronic device. The display device 200 may be connected with another electronic device over a network, according to the communication standard, such as BT, radio frequency identification (RFID), infrared data association (IrDA), ultra wideband (UWB), ZigBee, digital living network alliance (DLNA), or the like. The external device interface unit 220 may access various STBs 100 through at least one of the described various devices, and may perform input/output operation with the STB 100. The external device interface unit 220 may receive an application or an application list included in a neighboring external device, and may transfer the same to the controller 280 or the storage unit 240.

The user interface unit 230 may transfer a signal input by a user to the controller 280, or may transfer a signal from the controller 280 to the user. For example, the user interface unit 230 may receive a control signal (such as an activate/deactivate signal of the display device 200, a channel select signal, a screen setting signal, a volume control signal, or the like) from the remote control device 300 according to various communication schemes (such as an RF communication scheme, an infrared communication scheme, or the like), and may process the same, or may transmit a control signal from the controller 280 to the remote control device 300. The activate/deactivate signal of the display device 200 may be a signal for turning on or off the image outputting unit 250 in the state in which the display device 200 is being provided with power.

The storage unit 240 may store a program for processing and controlling each signal in the controller 280, and may store a signal-processed video, audio, or data signal. The storage unit 240 may temporarily store a video, an audio, or a data signal input from the external device interface unit 220 or the network interface unit 213, and may store information associated with a predetermined broadcasting channel through a channel memory function. The storage unit 240 may store a channel list generated by a user. The channel list may include at least one channel that a user adds as a favorite channel. The storage unit 240 may store EPG data obtained from the STB 100.

The image outputting unit 250 may display screen data processed in the controller 280. The image outputting unit 250 may use a plasma display panel (PDP), a liquid crystal display (LCD), an organic light emitting diode (OLED), a flexible display, a 3D display, or the like, and may be embodied as a touch screen and may be used as an input device in addition to an output device.

The audio outputting unit 260 may output audio data processed in the controller 280, and the audio outputting unit 260 may be embodied as various types of speakers.

The power supplying unit 270 may supply power to the entirety of the display device 200. The power supplying unit 270 may include a converter for converting an alternating current into a direct current. When the image outputting unit 250 is an LCD including a plurality of backlight lamps, the power supplying unit 270 may further include an inverter that is capable of performing a pulse width modulation (PWM) operation so as to change a latitude or to drive dimming.

The controller 280 may receive EPG data from the STB 100 periodically or in real time, and may store the same. When a signal for activating the image outputting unit 250 is received from the remote control device 300 through the user interface unit 230, the controller 280 may activate the image outputting unit 250. The controller 280 may display, in the image outputting unit 250, screen data included in content received from the STB 100 through the external device interface unit 220. The controller 280 may capture the displayed screen data, and may transmit the same to the server 400 through the network interface unit 213.

The controller 280 may receive content information related to the screen data from the server 400 through the network interface unit 213. The controller 280 may identify data having information that is the same as the content information received from the server 400, from among EPG data. When the data having information that is the same as the content information received from the server 400 is identified from among EPG data, the controller 280 may set a channel number included in the content information as a reference channel.

When a signal for calling a channel list is received from the remote control device 300 in the state in which content is being output, the controller 280 may display a channel list including at least one channel in the image outputting unit 250. The controller 280 may display the channel list to overlap screen data displayed in the image outputting unit 250. The channel list may be a list to which at least one channel is added by a user as a favorite channel.

When a signal for adding a channel is received from the remote control device 300 in the state in which a channel list is displayed, the controller 280 may add a determined channel number to the channel list. Similarly, when a signal for editing a channel list is received from the remote control device 300 in the state in which a channel list is displayed, the controller 280 may edit the channel list based on the edit signal. Likewise, when a delete signal for deleting at least one channel out of the channels included in a channel list is received, the controller 280 may delete the corresponding channel from the channel list. When a sequence change signal associated with at least one out of the channels included in a channel list is received, the controller 280 may change a sequence of the corresponding channel from the channel list.

When a channel change signal for changing a channel in a channel list is received from the remote control device 300 in the state in which the channel list is displayed, the controller 280 may change a current channel that provides a currently output content to another channel based on the channel change signal. The controller 280 may output content that is provided by the changed channel. When a channel change signal is received from the remote control device 300, the controller 280 may count the number of times that a channel change signal is input based on a predetermined reference channel. The controller 280 may determine, from the channel list, a channel corresponding to the number of times inputting, and may transmit the determined channel number to the remote control device 300. When transmitting the channel number, the controller 280 may generate and transmit a control signal to the remote control device 300 so that the channel number is included in an infrared signal. To this end, the remote control device 300 may include the channel number in the infrared signal, and may transmit the same to the STB 100. The controller 280 may receive, from the STB 100, content provided from a channel corresponding to a change signal, and may output the same.

The controller 280 may receive a channel change signal from the remote control device 300 in the state in which content received from the STB 100 is displayed through the image outputting unit 250. The channel change signal indicates a signal for directly changing a channel according to an up/down signal or an input signal associated with a predetermined number, which is input from the remote control device 300, instead of using a channel list. The controller 280 may sniff (or detect) a channel change signal output from the remote control device 300, and may determine a type of channel change signal of the sniffed channel change signal. The channel change signal sniffed by the controller 280 may be a channel change signal that the remote control device 300 outputs to the STB 100. The controller 280 may determine a type of channel change signal.

When the channel change signal sniffed by the remote control device 300 is an up/down signal, the controller 280 may add/subtract the up/down signal to/from a channel number (e.g., a reference channel) that provides a currently output content, and determine a channel number of a desired channel of the remote control device 300. When the channel change signal sniffed by the remote control device 300 is a signal associated with a predetermined number, the controller 280 may determine a channel number corresponding to the predetermined number as a channel number of a desired channel of the remote control device 300. The controller 280 may output content received from the STB 100. In this instance, the content received from the STB 100 may be content provided through a channel changed in the STB 100 in response to the channel change signal output from the remote control device 300. The controller 280 may determine a channel number determined in the controller 280 and a channel number that provides content received from the STB 100. The controller 280 may reset the channel number that provides the content received from the STB 100 as a reference channel, according to a result of the determination.

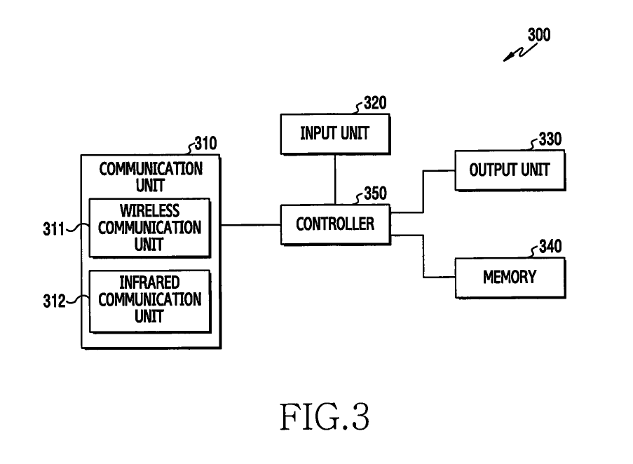

FIG. 3 is a block diagram illustrating a main configuration of a remote control device, according to an embodiment of the present disclosure.

Referring to FIG. 3, the remote control device 300 includes a communication unit 310, an input unit 320, an output unit 330, a memory 340, and a controller 350. The remote control device 300 may be a remote controller that may generate and output a signal for controlling the STB 100 and the display device 200, and may be an electronic device, such as a smart phone or the like.

The communication unit 310 may perform communication with the display device 200 and the STB 100, and the communication unit 310 may include a wireless communication unit 311 and an infrared communication unit 312. The wireless communication unit 311 may support one of the aforementioned short-range wireless communications for the transmission/reception of a signal with the display device 200. The infrared communication unit 312 may support infrared communication that may provide a signal to the STB 100.

The wireless communication unit 311 may transmit, to the display device 200, a control signal associated with the activation/deactivation of the display device 200, the changing of a channel, the changing of a volume, or the like. The wireless communication unit 311 may transmit, to the display device 200, a control signal for entering a channel list including at least one channel that a user adds as a favorite channel. The infrared communication unit 312 may transmit, to the STB 100, a control signal associated with turning on/off of a power source of the STB 100, changing a channel, or the like.

The input unit 320 may be formed of a keypad, a button, a touch pad, a touch screen, and the like. The input unit 320 may input a control signal for changing content that is currently transmitted from the STB 100 to the display device 200. The input unit 320 may input a control signal for controlling a channel list stored in the display device 200. When a control signal for changing content that is currently transmitted from the STB 100 to the display device 200 is input, the controller 350 may generate a control signal as an infrared signal, and transmit the same to the STB 100. When a control signal for controlling a channel list stored in the display device 200 is input, the controller 350 may generate a control signal as a short-range wireless signal and transmit the same to the display device 200.

The output unit 330 may include an LED module that is lit, a vibration module that vibrates, a sound outputting module that outputs sounds, or a display module that outputs image data when the input unit 320 is operated, or when a signal is transmitted/received to/from the display device 200 or the STB 100 through the communication unit 310.

The memory 340 may store various types of programs, application data, or the like, which are required to control and operate the remote control device 300. When the remote control device 300 wirelessly transmits/receives a signal to/from the display device 200 through the wireless communication unit 311, the remote control device 300 and the display device 200 may perform the transmission/reception of a signal through a predetermined frequency band. The memory 340 may store information associated with a frequency band or the like through which the memory 340 wirelessly transmits/receives a signal to/from the display device 200 that is paired with the remote control device 300.

The controller 350 may control general operations associated with the controlling of the remote control device 300. The controller 350 may output a signal corresponding to the operation of the input unit 320 to the outside of the remote control device 300 through the wireless communication unit 311 and/or the infrared communication unit 312. When a control signal including a channel number is received from the display device 200, the controller 350 may generate an infrared signal including the channel number and output the same to the outside of the remote control device 300.

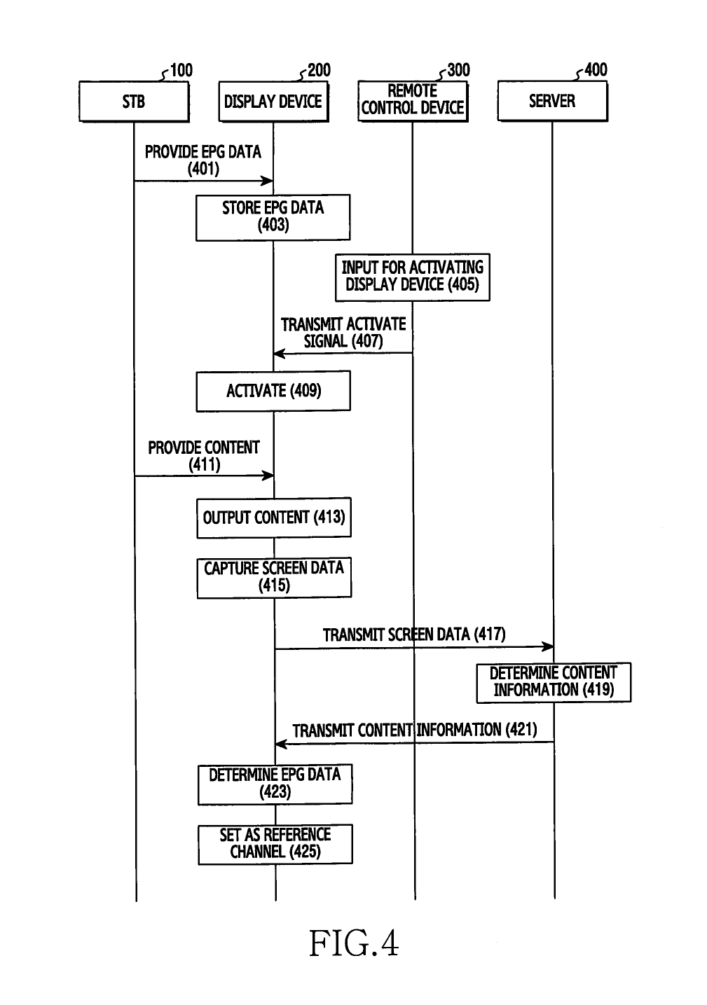

FIG. 4 is a signaling diagram of a method in which a system sets a reference channel, according to an embodiment of the present disclosure.

Referring to FIG. 4, the STB 100 transmits, to the display device 200, EPG data received from a broadcasting server in operation 401. The STB 100 may transmit, to the display device 200, the EPG data periodically or in real time in the state in which a communication channel with the display device 200 is established. The display device 200 stores the EPG data received from the STB 100 in operation 403.

When it is detected that an input for activating the display device 200 is provided by a user in operation 405, the remote control device 300 transmits an activate signal to the display device 200 in operation 407. The display device 200 is activated by the activate signal received from the remote control device 300 in operation 409. The signal for activating the display device 200 may be a signal for providing power to the image outputting unit 250 and the audio outputting unit 260 through the power supply unit 270 in order to activate the image outputting unit 250 and the audio outputting unit 260. When the image outputting unit 250 and the audio outputting unit 260 of the display device 200 are activated, the STB 100 provides content provided from a predetermined channel to the display device 200 in operation 411. The STB 100 may continuously provide content to the display device 200 until the communication connection with the display device 200 is terminated. Content provided to the display device 200 may be content associated with a predetermined channel selected by the display device 200 until the display device 200 is deactivated. Also, operation 401 in which the STB 100 provides EPG data to the display device 200 and operation 403 in which the display device 200 stores the EPG data may be performed after operation 409 in which the display device 200 is activated.

In operation 413, the display device 200 outputs the content received from the STB 100, through the image output unit 250 and the audio output unit 260. The content may be content provided from a predetermined channel, and the content may include screen data to be output through the image outputting unit 250 and sound data to be output through the audio outputting unit 260. In operation 415, the display device 200 captures the screen data output through the image outputting unit 250. In operation 417, the display device 200 transmits the captured screen data to the server 400.

In operation 419, the server 400 determines information associated with content corresponding to the screen data received from the display device 200. The server 400 may parse text included in the screen data, a time when the screen data is captured from the display device 200, and person information included in the screen data through facial recognition (e.g., feature points recognition), and the like. The server 400 may extract information associated with the content according to a result of the parsing operation being performed. The server 400 may determine the content information including metadata of at least one of a broadcasting company that provides content corresponding to screen data, a channel number of a channel that provides content, a title of content, a broadcasting start time of content, a broadcasting end time of content, a logo of content, a logo of a broadcasting company, and a thumbnail of content, according to the result of the parsing operation being performed. In operation 421, the server 400 transmits the determined content information to the display device 200.

In operation 423, the display device 200 determines whether information is the same as the received content information exists in the EPG data stored in operation 403. When it is determined that the information is the same as the content information exists in the EPG data, the display device 200 may determine a channel number associated with a channel that provides a currently output content, based on the determined information. In operation 425, the display device 200 sets the determined channel number as a reference channel. The operation of setting a reference channel by display device 200, which has been described above, may be performed when the STB 100 is switched from a deactivated state into an activated state, when the display device 200 is switched from a deactivated state into an activated state, and when a channel change signal is input from the remote control device 300 after a single content is displayed in the display device 200 during a predetermined period of time.

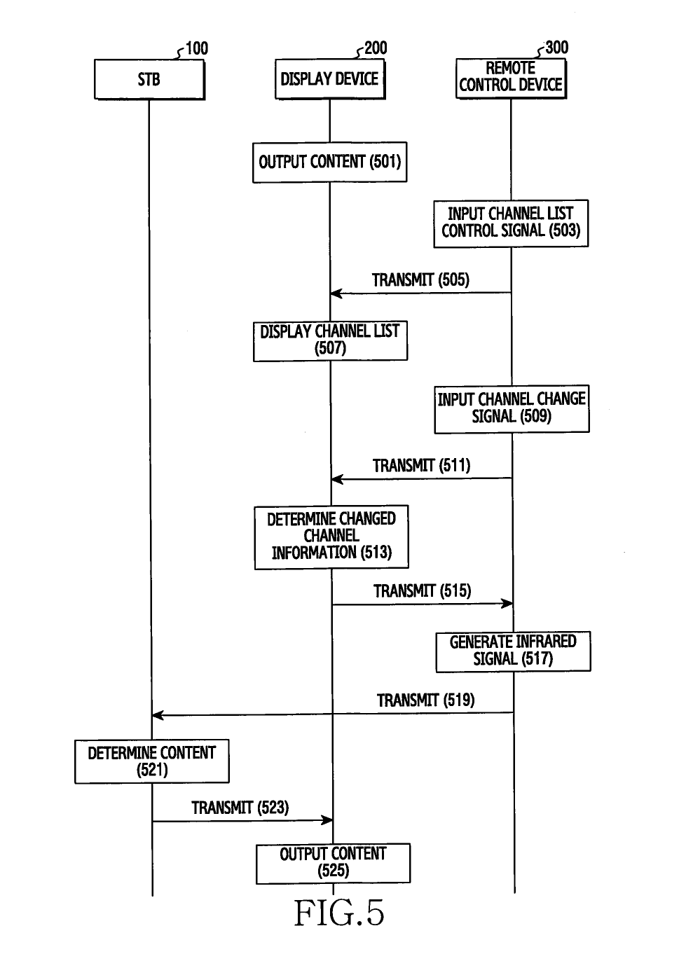

FIG. 5 is a signaling diagram of a method in which a system changes a channel in a channel list, according to an embodiment of the present disclosure.

Referring to FIG. 5, the display device 200 outputs content in operation 501. Content output from the display device 200 may be content that is provided from a predetermined channel that a user selects in the STB 100. The display device 200 outputs screen data included in the content through the image outputting unit 250, and may output sound data included in the content through the audio outputting unit 260. In operation 503, a user inputs, through the remote control device 300, a control signal for controlling a channel list stored in the display device 200. In operation 505, the remote control device 300 transmits, to the display device 200, the control signal input by the user. In operation 507, the display device 200 outputs the stored channel list to overlap the screen data output to the image outputting unit 250, in response to the control signal. The channel list may indicate a list to which a user adds at least one channel as a favorite channel.

In operation 509, the user inputs, through the remote control device 300, a channel change signal for changing a channel to a predetermined channel from among the channels included in the channel list. In operation 511, the remote control device 300 transmits the control signal input by the user to the display device 200. The remote control device 300 and the display device 200 may use short-range wireless communication, such as BLE or the like. In operation 513, the display device 200 determines information associated with a channel changed based on the channel change signal. For example, the display device 200 may determine whether a current channel that provides a currently output content is included in the channel list. When the current channel is included in the channel list, the display device 200 may change a channel as many times as the number of times that a channel change signal is input by using the current channel as a start point. The display device 200 may determine a channel number of a changed channel. When the current channel is not included in the channel list, the display device 200 may change a channel as many times as the number of times that a channel change signal is input from a channel ranked at the top of the channel list. The display device 200 may determine a channel number of a changed channel.

In operation 515, the display device 200 transmits the determined channel number to the remote control device 300. In operation 517, the remote control device 300 generates an infrared signal including the channel number received from the display device 200. In operation 519, the remote control device 300 transmits the generated infrared signal to the STB 100. In operation 521, the STB 100 determines the channel number included in the infrared signal transmitted from the remote control device 300, and determines content provided from the channel number. In operation 523, the server 100 transmits the determined content to the display device 200. In operation 525, the display device 200 outputs the content received from the STB 100.

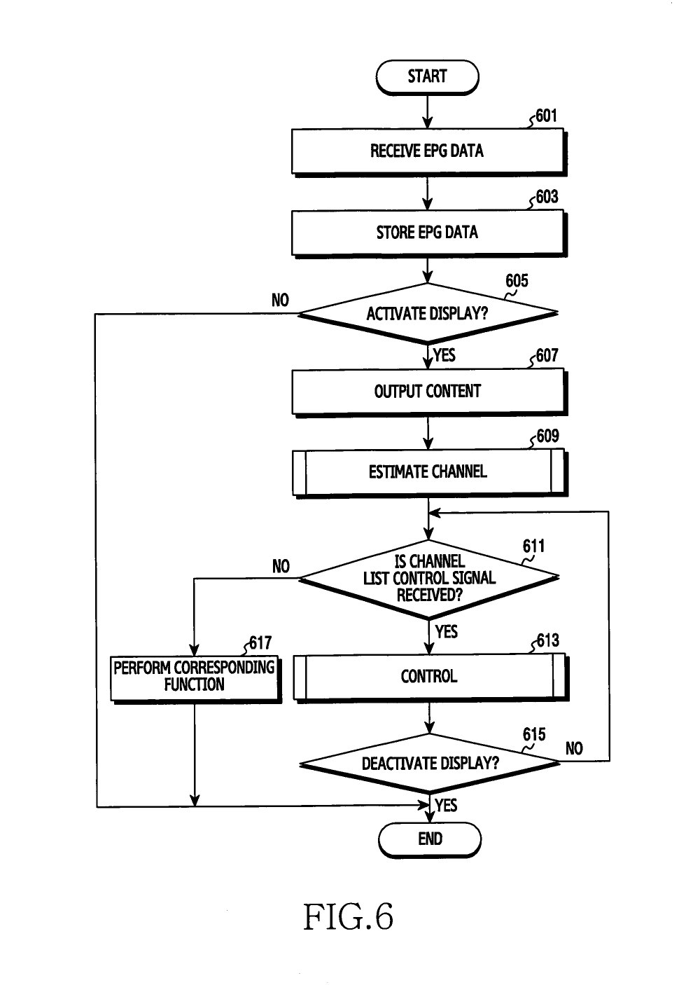

FIG. 6 is a flowchart of a method of a display device, according to an embodiment of the present disclosure.

Referring to FIG. 6, the display device 200 receives EPG data from the STB 100 in operation 601. The display device 200 may receive the EPG data periodically or in real time. In operation 603, the display device 200 stores the EPG data. When the display device 200 receives an activate signal of the display device 200 in operation 605, the display device 200 proceeds with operation 607. The activate signal may be a signal for supplying power to the image outputting unit 250 and the audio outputting unit 260. For example, in the state in which the image outputting unit 250 and the audio outputting unit 260 are not activated although power is continuously supplied to the display device 200, the display device 200 may receive the EPG data from the STB 100.

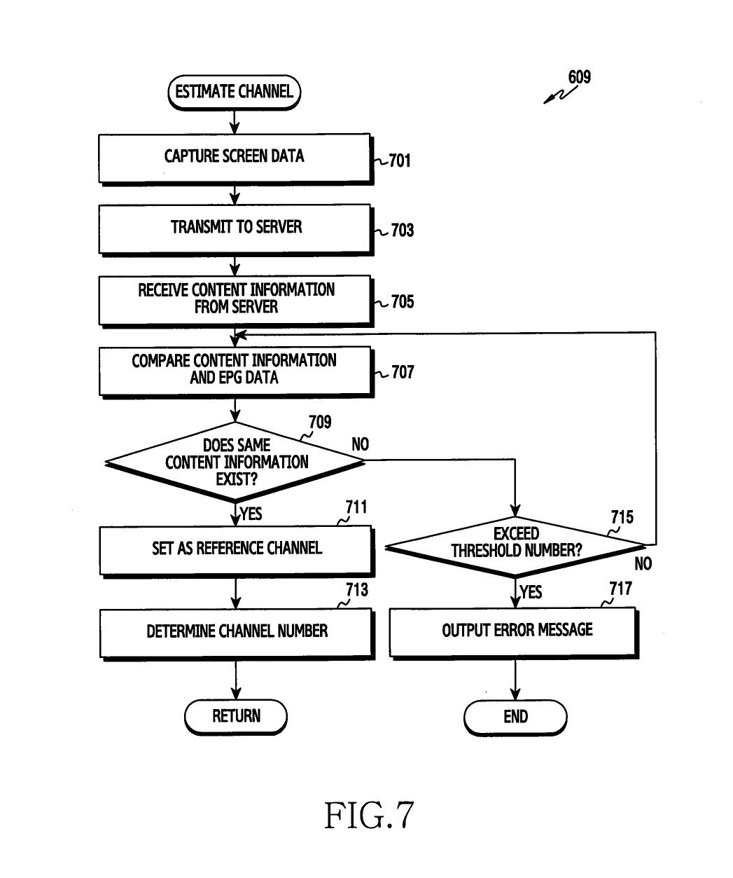

In operation 607, the display device 200 outputs content received from the STB 100, through the image output unit 250 and the audio output unit 260. The content may include screen data and sound data. The screen data may be output through the image outputting unit 250, and the sound data may be output through the audio outputting unit 260. In operation 609, the display device 200 estimates a channel number of a channel that provides the currently output content; this will be described in greater detail with reference to FIG. 7.

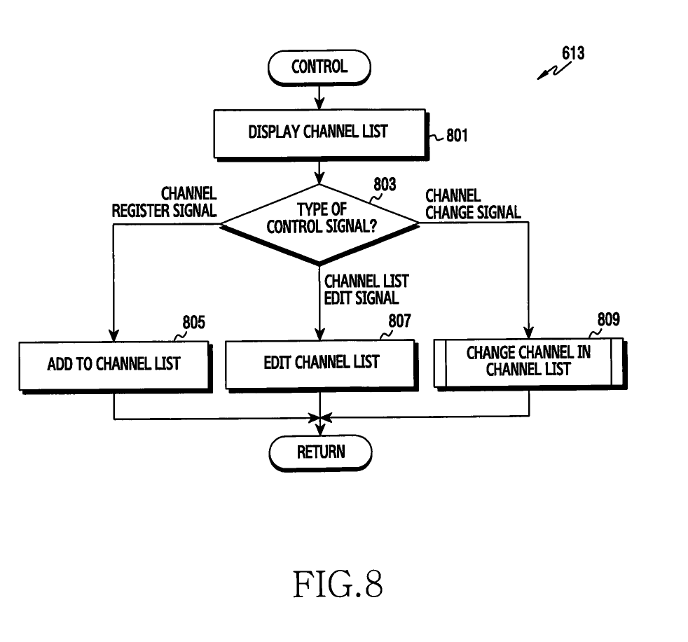

In operation 611, the display device 200 determines whether a signal for controlling a channel list is received from the remote control device 300. When the signal for controlling the channel list is not received in operation 611, the display device 200 proceeds with operation 617. In operation 617, the display device 200 receives various signals such as a volume control signal or the like, and performs a corresponding function. When the signal for controlling the channel list is received in operation 611, the display device 200 proceeds with operation 613. In operation 613, the display device 200 performs controlling based on the control signal; this will be described in greater detail with reference to FIG. 8. When the display device 200 receives a deactivate signal of the display device 200 in operation 615, the display devices 200 terminates the process. When the deactivate signal is not received in operation 615, the display device 200 returns to operation 611, and performs the above described operations again.

FIG. 7 is a flowchart of a method in which a display device estimates a currently viewed channel, according to an embodiment of the present disclosure.

Referring to FIG. 7, in operation 701, the display device 200 captures the screen data, which has been displayed in the image outputting unit 250 in operation 607 of FIG. 6. In operation 703, the display device 200 transmits the captured screen data to the server 400. In operation 705, the display device 200 receives content information from the server 400. The content information may include metadata of at least one of a broadcasting company that provides content corresponding to screen data, a channel number of a channel that provides content, a title of content, a broadcasting start time of content, a broadcasting end time of content, a logo of content, a logo of a broadcasting company, and a thumbnail of content.

In operation 707, the display device 200 compares the received content information and the EPG data, which has been stored in operation 603 of FIG. 6, and searches the EPG data for information that is the same as the received content information. When the information that is the same as the content information exists in the EPG data in operation 709, the display device 200 proceeds with operation 711. In operation 711, the display device 200 determines the EPG data having the same information, and sets a channel that provides the currently output content of operation 607 of FIG. 6 as a reference channel. In operation 713, the display device 200 determines a channel number of the channel that provides the currently output content of operation 607 of FIG. 6. The sequences of operation 711 and operation 713 may be changed. In operation 713, the display device 200 that determines the channel number returns to FIG. 6 and performs operation 611.

When the information is not the same as the content information in the EPG data in operation 709, the display device 200 proceeds with operation 715. When the number of times that the information that is the same as the information associated with the currently output content is not identified from the EPG data exceeds a predetermined threshold number in operation 715, the display device 200 proceeds with operation 717. In operation 717, the display device 200 displays, in the image outputting unit 250, a message indicating that channel estimation is not allowed. In operation 715, the display device 200 returns to operation 707 when the number of times that the information that is the same as the information associated with the currently output content is not identified from the EPG data does not exceed a predetermined threshold number.

FIG. 8 is a flowchart of a method in which a display device controls a channel list, according to an embodiment of the present disclosure.

Referring to FIG. 8, in operation 801, the display device 200 displays the channel list stored in the display device 200 through the image outputting unit 250, based on the signal for controlling the channel list, which has been received in operation 611 of FIG. 6. The channel list may indicate a list to which a user adds at least one channel as a favorite channel. The display device 200 determines a type of control signal of the control signal received from the remote control device 300 in operation 803. When a result of the determination of operation 803 shows that the control signal is a channel register signal, the display device 200 may proceed with operation 805. The display device 200 proceeds with operation 807 when the control channel is a channel list edit signal. The display device 200 proceeds with operation 809 when the control channel is a channel change signal. The channel change signal may be a signal for changing a channel in the channel list.

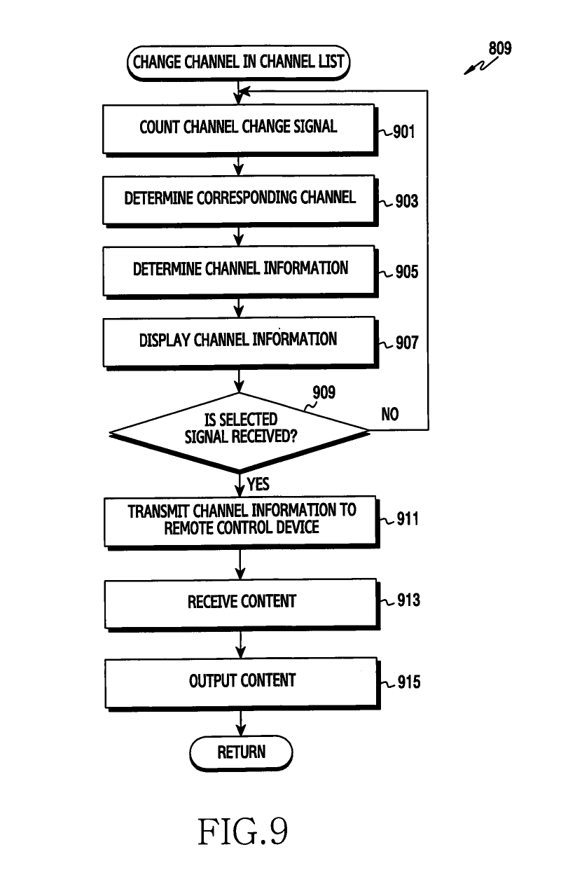

In operation 805, the display device 200 adds a channel to the channel list. The display device 200 may add the channel number, which has been determined in operation 713 of FIG. 7, and may update the channel list. In operation 807, the display device 200 edits the channel list. The display device 200 may delete, from the channel list, at least one channel included in the channel list in response to an edit signal received from the remote control device 300. The display device 200 may change a sequence of at least one channel included in the channel list in response to an edit signal received from the remote control device 300. In operation 809, the display device 200 changes the current channel that provides the currently output content to a channel selected out of the channels included in the channel list, based on the channel change signal; this will be described in greater detail with reference to FIG. 9.

FIG. 9 is a flowchart of a method in which a display device changes a channel in a channel list, according to an embodiment of the present disclosure.

Referring to FIG. 9, the display device 200 counts the number of times that a channel change signal received from the remote control device 300 is input, in operation 901. In operation 903, the display device 200 changes a channel as many times as the counted number of times of inputting, in the channel list displayed in the image outputting unit 250, and determines a changed channel. In operation 905, the display device 200 determines information associated with the changed channel. The display device 200 may determine, from EPG data, information, such as a channel number of a changed channel, a title of content that is currently provided from a channel number, a broadcasting start time of content, a broadcasting end time of content, a thumbnail of content, and the like. In operation 907, the display device 200 displays, in the image outputting unit 250, channel information associated with the changed channel.

The display device 200 proceeds with operation 911 when the changed channel is selected in operation 909, and the display device 200 returns to operation 901 to count the number of times that a channel change signal is input when the corresponding channel is not selected. In operation 911, the display device 200 transmits information associated with the selected channel to the remote control device 300. The display device 200 transmits a channel number from among information associated with the channel to the remote control device 300. The display device 200 may transmit a control signal including the channel number to the remote control device 300 so that the remote control device 300 generates an infrared signal including the channel number.

In operation 913, the display device 200 receives, from the STB 100, content corresponding to the channel selected in operation 909. In operation 915, the display device 200 outputs the received content. The display device 200 may output screen data included in the content to the image outputting unit 250, and may output sound data to the audio output unit 260. Therefore, the remote control device 300 may transmit the selected channel number to the STB 100 through the display device 200, and the STB 100 may transmit content corresponding to the channel number to the display device 200. Therefore, a user may quickly determine the selected content from the channel list.

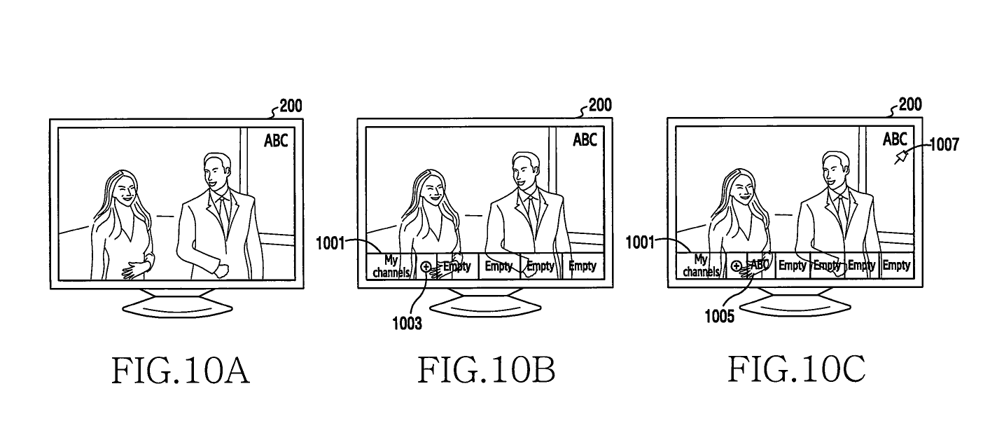

FIGS. 10A to 10C are diagrams illustrating screens in association with a method for a display device to register a currently viewed channel in a channel list, according to an embodiment of the present disclosure.

The display device 200 displays screen data as shown in FIG. 10A. The screen data of FIG. 10A may be screen data included in content that is provided by ABC channel. The display device 200 may capture the currently displayed screen data and may transmit the captured screen data to the server 400.

The server 400 may analyze the screen data, and may determine content having screen data similar to the screen data. The server 400 may extract information associated with the determined content and may transmit the same to the display device 200. The server 400 may parse text included in the screen data, a time when the screen data is captured from the display device 200, and facial recognition (e.g., feature points recognition) included in the screen data, and the like. The server 400 may extract information associated with the content and may transmit the same to the display device 200, according to a result of the parsing operation being performed. The content information may include metadata of at least one of a broadcasting company that provides the content corresponding to the screen data, a channel number of a channel that provides the content, a title of the content, a broadcasting start time of the content, a broadcasting end time of the content, a logo of the content, a logo of a broadcasting company, and a thumbnail of the content. The channel number may be for example, 11, which may be allocated to the ABC channel. The display device 200 may determine whether information that is the same as the content information exists in EPG data. When the information that is the same as the content information exists in the EPG data, the display device 200 may set the ABC channel as a reference channel, and may determine that the number allocated to the ABC channel is 11.

When a signal for controlling a channel list is received from the remote control device 300, the display device 200 may display a channel list 1001 to overlap the screen data as shown in FIG. 10B. The display device 200 may receive, from the remote control device 300, a control signal for adding a predetermined channel to the channel list 1001. When an add icon 1003 for adding a channel is selected by the remote control device 300, the display device 200 may add the ABC channel that provides a currently output content (that is, the channel number 11) to the channel list 1001, as shown in FIG. 10C.

The display device 200 may add content information including a channel number allocated to the ABC channel, when adding the ABC channel to the channel list 1001. The display device 200 may display the added ABC channel 1005 in the channel list 1001. When the ABC channel is added to the channel list 1001, the display device 200 may display, in a part of the screen data, an icon 1007 indicating that the ABC channel is added to the channel list 1001.

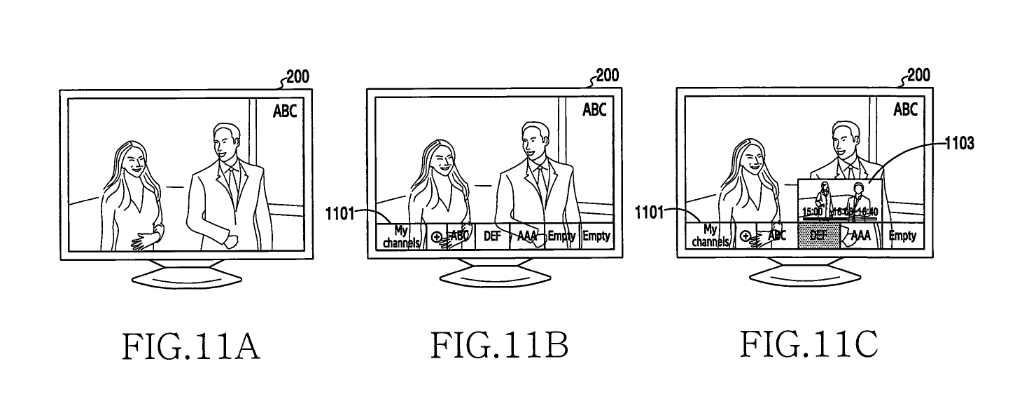

FIGS. 11A to 11C are diagrams illustrating screens in association with a method for a display device to change a currently viewed channel to another channel in a channel list, according to an embodiment of the present disclosure.

Referring to FIGS. 11A to 11C, the display device 200 displays screen data as shown in FIG. 11A. The screen data of FIG. 11A may be screen data included in content that is provided by the ABC channel. When a signal for controlling a channel list is received from the remote control device 300 in the state in which the screen data is displayed, the display device 200 may display a channel list 1101 to overlap the screen data as shown in FIG. 11B. The display device 200 may receive, from the remote control device 300, a signal for changing a channel in the channel list.

The display device 200 may count the number of times that a channel change signal received from the remote control device 300 is input. For example, the display device 200 may count the number of times that a channel up/down signal received from the remote control device 300 is input. The display device 200 may change a channel as many times as the counted number of times of inputting in the channel list 1101 displayed in the image outputting unit 250. When a channel associated with a currently output content is the ABC channel and the ABC channel is included in the channel list 1101, the display device 200 may change a channel as many times as the counted number of times of inputting by using the ABC channel as a start point. For example, in the state in which the channel list 1101 is displayed and the channel associated with the currently output content is the ABC channel, when a channel up signal is input one time, the display device 200 may display DEF channel to be emphasized or highlighted to distinguish it from the other channels. The display device 200 may display AAA channel to be emphasized when a channel up signal is input two times. When the channel associated with the currently output content is not the ABC channel (that is, when the ABC channel is not included in the channel list 1101), the display device 200 may display the ABC channel to be emphasized when a channel up signal is input one time. The display device 200 may display the DEF channel to be emphasized when a channel up signal is input two times. The display device 200 may display the AAA channel to be emphasized when a channel up signal is input three times.

The display device 200 may display and emphasize a predetermined channel to correspond to an up signal for channel changing received from the remote control device 300. When a control signal is not received from the remote control device 300 during a threshold time in the state in which the predetermined channel is emphasized, the display device 200 may enlarge and display detailed channel information 1103 of the predetermined channel on the top of the channel list 1101. For example, when a control signal is not received from the remote control device 300 during a threshold time in the state in which the DEF channel is displayed to be emphasized, the display device 200 may display the detailed channel information 1103 of the DEF channel to overlap the screen data, as shown in FIG. 11C. The detailed channel information 1103 may include a thumbnail associated with screen data included in content that is currently broadcasted in the DEF channel. The detailed channel information 1103 may display a start time of a currently broadcasted content, an end time, an amount of time that content is broadcasted, or the like as a progress bar in the bottom of the thumbnail.

When a select signal for selecting the DEF channel is input from the remote control device 300, the display device 200 may determine the channel number allocated to the DEF channel. The display device 200 may transmit a control signal including a channel number to the remote control device 300 so that the remote control device 300 generates an infrared signal including the determined channel number. The remote control device 300 may generate an infrared signal including the channel number, and may transmit the same to the STB 100. The STB 100 determines the channel number included in the infrared signal, received from the remote control device 300, and transmits content that is currently broadcasted from the determined channel number to the display device 200. The display device 200 may output the content received from the STB 100.

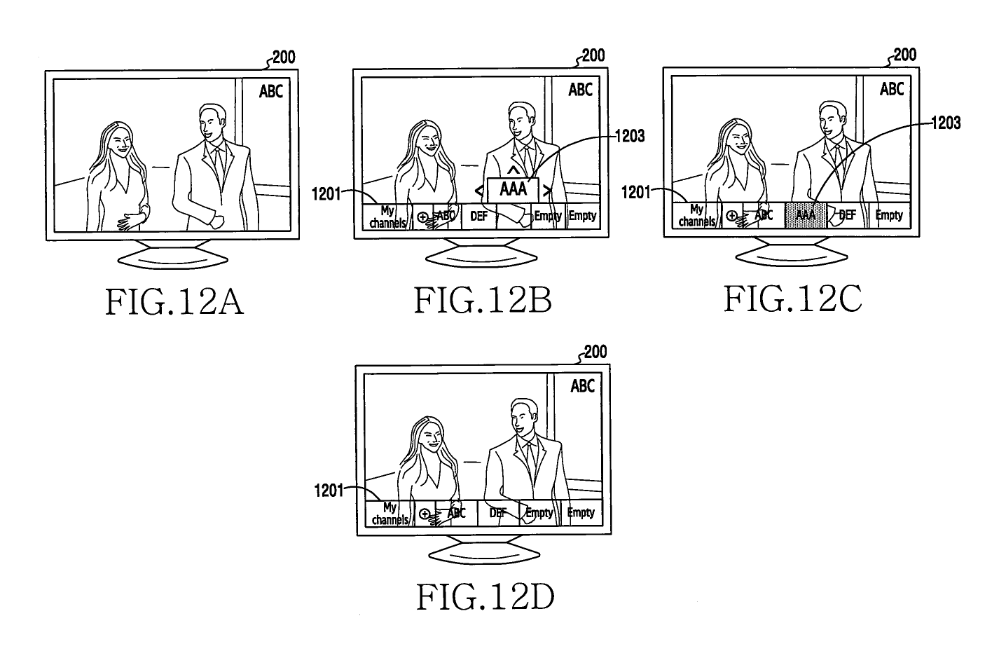

FIGS. 12A to 12D are diagrams illustrating screens in association with a method for a display device to edit a channel list, according to an embodiment of the present disclosure.

Referring to FIGS. 12A to 12D, the display device 200 displays screen data as shown in FIG. 12A. The screen data of FIG. 12A may be screen data included in content that is provided by the ABC channel. When a signal for controlling a channel list is received from the remote control device 300 in the state in which the screen data is displayed, the display device 200 may display a channel list 1201 to overlap the screen data as shown in FIG. 12B. The display device 200 may receive, from the remote control device 300, a signal for editing the channel list.

The display device 200 may determine the edit signal received from the remote control device 300. For example, the display device 200 may count the number of channel up/down signals received from the remote control device 300. The display device 200 may change a channel as many times as the counted channel change signals, in the channel list 1201 displayed in the image outputting unit 250. The display device 200 may count the number of channel up/down signals received from the remote control device 300 in the state in which the channel list 1201 is displayed in the display device 200. The display device 200 changes a channel to a channel corresponding to the up/down signal from among the channels included in the channel list 1201. For example, the display device 200 may change a channel to AAA channel 1203 based on an up/down signal. The display device 200 may display the AAA channel 1203 to be emphasized. When an up signal is received from the remote control device 300 in the state in which the AAA channel 1203 is displayed to be emphasized, the display device 200 may display the AAA channel 1203 in the top of the channel list 1201 as shown in FIG. 12B. The display device 200 may display arrows in the left side, the right side, and the top of the AAA channel 1203, respectively.

When a left signal is received from the remote control device 300 in the state in which the AAA channel 1203 is selected as shown in FIG. 12B, the display device 200 may change the sequence of the AAA channel 1203 in the channel list 1201, as shown in FIG. 12C. When an up signal is received from the remote control device 300 in the state in which the AAA channel 1203 is selected as shown in FIG. 12B, the display device 200 may delete the AAA channel 1203 from the channel list 1201 as shown in FIG. 12D.

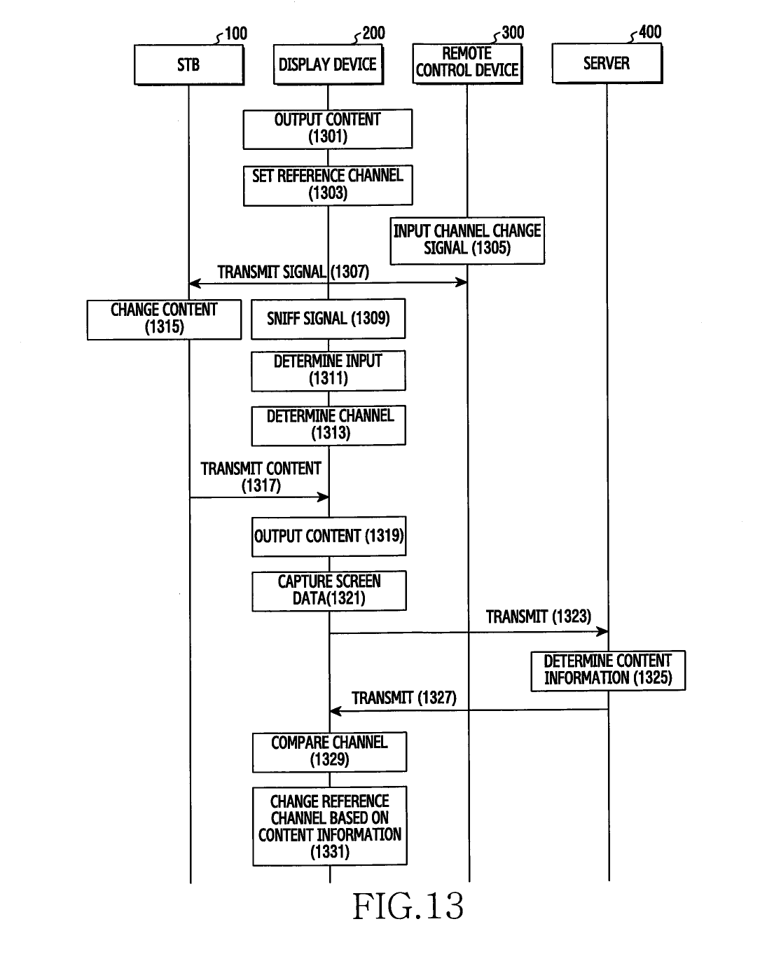

FIG. 13 is a flowchart of a method for a system to set a reference channel when changing a channel, according to an embodiment of the present disclosure.

Referring to FIG. 13, the display device 200 outputs content received from the STB 100 in operation 1301. Although not illustrated, the content output from the display device 200 may be content that is provided from a predetermined channel that a user selects in the STB 100. The display device 200 may output screen data through the image outputting unit 250, and may output sound data through the audio outputting unit 260. In operation 1301, the display device 200 sets a channel that provides the currently output content as a reference channel. A method of setting content that is currently output as a reference channel has been described in detail with reference to FIG. 7, and thus, detailed descriptions thereof will be omitted.

When a channel change signal for changing the content that is currently output to another content is input from a user in operation 1305, the remote control device 300 transmits a channel change signal to the STB 100 in operation 1307. The channel change signal may be a signal for changing a channel that provides a currently output content to another channel, irrespective of a channel list. In operation 1309, the display device 200 sniffs the channel change signal output from the remote control device 300. The display device 200 may sniff the channel change signal through short-range wireless communication such as BLE or the like.

In operation 1311, the display device 200 determines that the channel change signal is input by the remote control device 300. For example, in operation 1311, the display device 200 may determine whether the channel change signal input by the remote control device 300 is an up/down signal, and may count the number of times that the up/down signal is input. Also, in operation 1311, the display device 200 determines whether the channel change signal input from the remote control device 300 is a signal provided by inputting a predetermined number, and determines a signal associated with the predetermined number.

In operation 1313, the display device 200 determines a channel corresponding to the channel change signal that is input by the remote control device 300. The display device 200 may determine a desired channel number of the remote control device 300 by adding/subtracting the counted input signals to/from a channel number of the channel that provides the currently output content. For example, when the current set reference channel is 11 and an up signal is input by the remote control device 300 three times, the display device 200 may determine that the desired channel number is 14. The display device 200 may determine a channel number corresponding to an input predetermined number at the channel that provides the currently output content. For example, the display device 200 may determine that the current set reference channel is 11, and the predetermined number input by the remote control device 300 is 14.

In operation 1315, the STB 100 changes a channel based on an infrared signal received from the remote control device 300, and accordingly, changes the content that is currently transmitted to the display device 200. The infrared signal may be an up/down signal which is a channel change signal input by the remote control device 300, or may be a signal associated with a predetermined number input by the remote control device 300. In operation 1317, the STB 100 transmits a changed content to the display device 200. In operation 1319, the display device 200 changes the content has been output in operation 1301 to the content received from the STB 100 in operation 1317, and outputs the changed content. In operation 1321, the display device 200 captures screen data associated with the output content. In operation 1323, the display device 200 transmits the captured screen data to the server 400.

In operation 1325, the server 400 determines information associated with the content using the screen data. The server 400 may determine content having screen data similar to the screen data. The server 400 may determine the information associated with the determined content. The content information may include metadata of at least one of a broadcasting company that provides the content corresponding to the screen data, a channel number of a channel that provides the content, a title of the content, a broadcasting start time of the content, a broadcasting terminate time of the content, a logo of the content, a logo of a broadcasting company, and a thumbnail of the content. In operation 1327, the server 400 transmits the determined content information to the display device 200.

In operation 1329, the display device 200 compares the channel number determined in operation 1313 and a channel associated with the content information received from the server 400 of operation 1327. In operation 1331, the display device 200 changes the reference channel set in operation 1303 based on the channel associated with the content information. For example, when the channel number determined to be a channel that the display device 200 desires is 14, and the channel number identified from the content received from the server 400 is 13, the display device 200 may set 13 as a reference channel. This can occur when an input speed of the remote control device 300 and a reaction speed of the display device 200 and a reaction speed of the STB 100 are different. Also, the channel number determined to be a channel that the display device 200 desires is 14, and the channel number identified from the content received from the server 400 is 1, the display device 200 may set 1 as a reference channel. This can occur when one of the display device 200 and the STB 100 loses an input from the remote control device 300. Therefore, a channel is changed according to an input from the remote control device 300, and on the basis of content that the display device 200 receives from the STB 100.

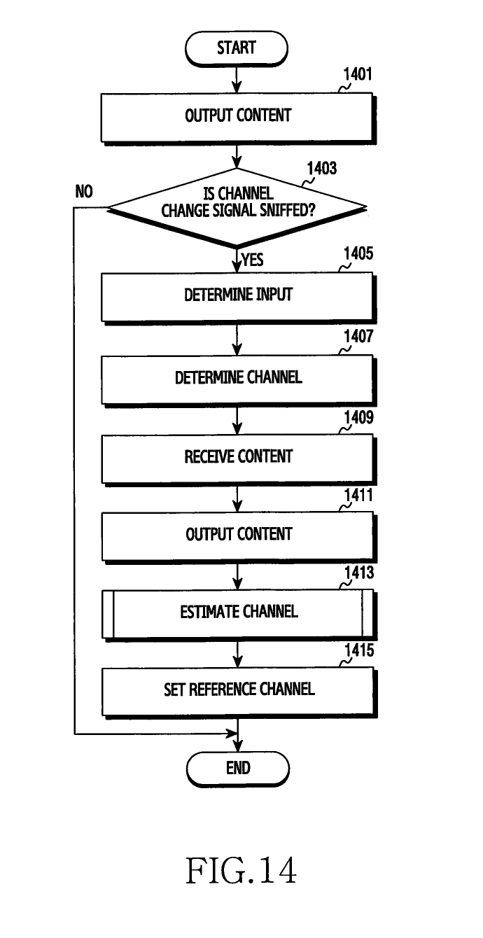

FIG. 14 is a flowchart of a method for a display device to change a reference channel as a channel is changed, according to an embodiment of the present disclosure.

Referring to FIG. 14, the display device 200 outputs content received from the STB 100 in operation 1401. In operation 1403, the display device 200 sniffs a channel change signal output from the remote control device 300. The remote control device 300 outputs a channel change signal as an infrared signal or a BLE signal. The display device 200 may sniff a BLE signal output from the remote control device 300.

In operation 1405, the display device 200 determines that the channel change signal is input, which is output from the remote control device 300. When an up/down signal is input by the remote control device 300, the display device 200 may count the number of input signals. When a signal associated with a predetermined number is input by the remote control device 300, the display device 200 may determine the input number. In operation 1407, the display device 200 determines a channel corresponding to the determined input. When an up/down signal is input by the remote control device 300, the display device 200 may add/subtract the counted number of channel change signals to/from a channel number corresponding to a currently output content, and determines a channel number of a channel that the remote control device 300 desires. For example, when a channel number that provides content currently output by the display device 200 is 11 and an up signal is output by the remote control device 300 three times as a channel change signal, the display device 200 may determine that a desired channel is 14. When a signal associated with a predetermined number is input by the remote control device 300, the display device 200 may determine the predetermined number as a channel number that the remote control device 300 desires.

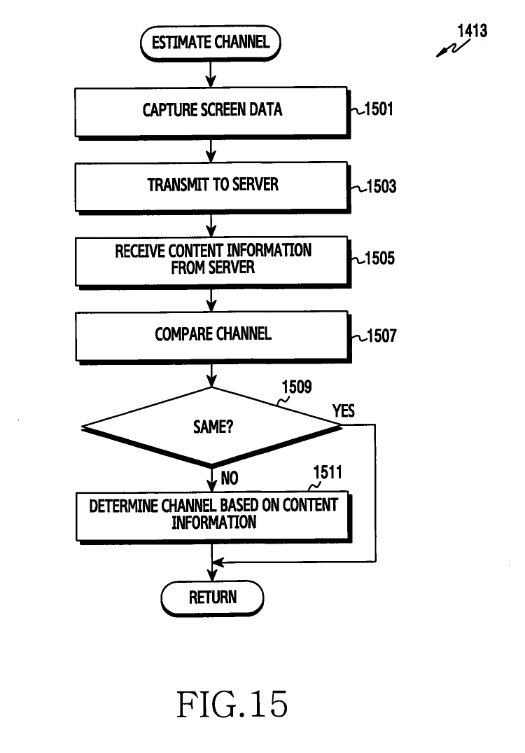

In operation 1409, the display device 200 receives content from the STB 100. The content may be content that is provided by a channel changed according to a channel change signal which is an infrared signal output by the remote control device 300. The STB 100 changes a channel according to a channel change signal output from the remote control device 300, and may transmit content changed according to channel changing to the display device 200. In operation 1411, the display device 200 changes the content that has been output in operation 1401, and outputs a changed content. In operation 1413, the display device 200 estimates a channel associated with the changed output content; this will be described in greater detail with reference to FIG. 15. In operation 1415, the display device 200 sets the channel estimated in operation 1413 as a reference channel.

FIG. 15 is a flowchart of a method for a display device to estimate a changed channel, according to an embodiment of the present disclosure.

Referring to FIG. 15, in operation 1501, the display device 200 captures the screen data that has been displayed in operation 1411 of FIG. 14. In operation 1503, the display device 200 transmits the captured screen data to the server 400. In operation 1505, the display device 200 receives content information from the server 400. The server 400 analyzes the screen data received from the display device 200, and may extract content similar to the screen data from a plurality of contents that are currently broadcasted. The server 400 may transmit information associated with the extracted content to the display device 200. The content information may include metadata of at least one of a channel number of a channel that provides content, a title of content, a broadcasting start time of content, a broadcasting terminate time of content, a logo of a content, a logo of a broadcasting company, and a thumbnail of content.

In operation 1507, the display device 200 compares the channel number of the channel that has been determined in operation 1407 and the channel number associated with the content information that has been received from the server 400 in operation 1505. When two channel numbers are the same in operation 1509, the display device 200 may return to operation 1415 of FIG. 14. When two channel numbers are different in operation 1509, the display device 200 may proceed with operation 1511. In operation 1511, the display device 200 determines a channel number based on the content information received from the server 400, and may return to operation 1415 of FIG. 14.

At least some parts of a device (e.g., modules or functions thereof) or a method (e.g., operations), based on embodiments of the present disclosure, can be implemented with an instruction stored in a non-transitory computer-readable storage medium (e.g., the memory 340) as a program module. When the instruction is executed by a processor (e.g., the controller 280), the processor can perform a function corresponding to the instruction. The non-transitory computer readable recording medium can include, for example, a hard disk, a floppy disc, a magnetic medium (e.g., a magnetic tape), an optical storage medium (e.g., a Compact Disc-ROM (CD-ROM) or a DVD, a magnetic-optic medium (e.g., a floptical disc)), and an internal memory. The instruction can include code created by a compiler or code executable by an interpreter.

The module or program module can further include at least one or more components among the aforementioned components, or can omit some of them, or can further include additional other components. Operations performed by a module, program module, or other components described herein can be executed in a sequential, parallel, repetitive, or heuristic manner. In addition, some of the operations can be executed in a different order or may be omitted, or other operations may be added.

While the present disclosure has been shown and described with reference to certain embodiments thereof, it will be understood by those skilled in the art that various changes in form and details may be made therein without departing from the scope of the present disclosure. Therefore, the scope of the present disclosure should not be defined as being limited to the embodiments, but should be defined by the appended claims and equivalents thereof.

What is claimed is:

1. A method for use with a display device, the method comprising:
outputting content corresponding to a predetermined channel;
capturing screen data included in the outputted content;
determining content information associated with the screen data from a previously stored electronic program guide; and
setting the predetermined channel as a reference channel based on the determined content information.

2. The method of claim 1, wherein setting the reference channel comprises:
determining a channel number of the predetermined channel.

3. The method of claim 2, wherein the content information includes at least one of a broadcating company that provides the content, a channel number allocated to the broadcasting company, a title of the content, a broadcasting start time of the content, a broadcasting end time of the content, a logo of the content, a logo corresponding to the channel number, and a thumbnail of the content.

4. The method of claim 2, further comprising:
receiving a control signal that requests displaying a favorite channel list; and
displaying the favorite channel list in a part of the display device to which the content is output in response to the received control signal, and controlling the favorite channel list based on the reference channel.

5. The method of claim 4, wherein controlling the favorite channel list comprises:
counting a number of times that a channel change signal received from a remote control device is input;
determining a channel corresponding to the counted number of times based on the reference channel in the favorite channel list;
when the channel corresponding to the counted number of times is selected, transmitting a channel number of the selected channel to the remote control device; and
receiving content corresponding to the channel number of the selected channel from a set top box, and outputting the content.

6. The method of claim 5, wherein transmitting the channel number to the remote control device further comprises:
transmitting a control signal to enable the remote control device to change the channel number into an infrared signal, and to transmit the infrared signal to the set top box.

7. The method of claim 4, wherein controlling the favorite channel list comprises:
adding the predetermined channel to the favorite channel list based on a reception of a control signal that requests registration of the predetermined channel.

8. The method of claim 4, wherein controlling the favorite channel list comprises:
deleting at least one favorite channel included in the favorite channel list, based on a reception of a control signal that requests deletion of the favorite channel.

9. The method of claim 4, wherein controlling the favorite channel list comprises:
changing a sequence of a plurality of channels included in the favorite channel list based on a control signal that requests changing a sequence of the plurality of channels.

10. The method of claim 2, further comprising:
detecting a channel change signal input from a remote control device;
counting the number of times that the detected channel change signal is input;
determining a desired channel number using the counted number of times;
outputting content received from a set top box, and capturing screen data included in the content;
comparing a channel number included in content information associated with the screen data and the determined channel number; and
changing the set reference channel according to the content information based on comparing the channel number included in content information associated with the screen data and the determined channel number.

11. An electronic device, comprising:
an image outputting unit configured to display screen data included in content corresponding to a predetermined channel; and
a controller configured to capture the screen data, determine content information associated with the screen data from an electronic program guide, and set the predetermined channel as a reference channel according to the determined content information.

12. The electronic device of claim 11, wherein the controller is further configured to determine a channel number of the predetermined channel.

13. The electronic device of claim 12, wherein the content information includes at least one of a broadcating company that provides the content, a channel number allocated to the broadcasting company, a title of the content, a broadcasting start time of the content, a broadcasting end time of the content, a logo of the content, a logo corresponding to the channel number, and a thumbnail of the content.

14. The electronic device of claim 12, wherein the controller is further configured to receive a control signal that requests displaying a favorite channel list, display the favorite channel list in a part of the image outputting unit to which the content is output based on the control signal, and control the favorite channel list based on the reference channel.

15. The electronic device of claim 14, wherein the controller is further configured to count a number of times that a channel change signal received from a remote control device is input, determine a channel corresponding the counted number of times, transmit, to the remote control device, a channel number of the channel corresponding to the counted number of times, and receive, from a set top box, content corresponding to the channel number of the selected channel.

16. The electronic device of claim 15, wherein the controller is further configured to generate a control signal to enable the remote control device to change the channel number into an infrared signal and to transmit the infrared signal to the set top box.

17. The electronic device of claim 14, wherein the controller is further configured to add the predetermined channel to the favorite channel list according to a control signal that requests registration of the predetermined channel.

18. The electronic device of claim 14, wherein the controller is further configured to delete at least one favorite channel included in the favorite channel list according to a control signal that requests deletion of the favorite channel.

19. The electronic device of claim 14, wherein the controller is further configured to change a sequence of a plurality of channels included in the favorite channel list according to a control signal that requests changing a sequence of the plurality channels.

20. The electronic device of claim 12, wherein the controller is further configured to detect a channel change signal input from a remote control device; count the number of times that the detected channel change signal is input, determine a desired channel number using the counted number of times, compare a channel number included in content information associated with a content receive from a set top box and the determined channel number, and change the set reference channel according to the content information based on comparing the channel number included in content information associated with the screen data and the determined channel number.
